(19) United States
(12) Patent Application Publication
(10) Pub. No.: US 2026/0314625 A1
(43) Pub. Date: Oct. 15, 2026

(54) A VEGETABLE FAT COMPOSITION FOR EDIBLE APPLICATIONS

(71) Applicant: AAK AB (PUBL), Malmö (SE)

(72) Inventor: Morten Daugaard ANDERSEN, Aarhus C (DK)

(21) Appl. No.: 18/847,432

(22) PCT Filed: Apr. 4, 2023
(86) PCT No.: PCT/SE2023/050304

§ 371 Date: Sep. 16, 2024

(30) Foreign Application Priority Data
Apr. 7, 2022 (SE) 2250441-9

(51) Int. Cl. A23G 1/46; A23G 1/38

(52) U.S. Cl. CPC A23G 1/46; A23G 1/38

(57) ABSTRACT

Disclosed is a robust milk edible application composition that has a significantly better cocoa butter/cocoa mass tolerance than existing solutions and the use of the edible application composition. Further disclosed is the use of a fat composition comprising a milk containing component for increasing the cocoa butter tolerance in an edible application composition.

### TECHNICAL FIELD OF THE INVENTION

The present invention relates to an robust milk edible application composition that has a significantly better cocoa butter/cocoa mass tolerance than existing solutions and the use of the edible application composition. The invention also relates to use of a fat composition comprising a milk containing component for increasing the cocoa butter tolerance in an edible application composition.

### BACKGROUND OF THE INVENTION

Fast crystallizing compounds (in traditional terminology Cocoa Butter Substitutes or CBS) generally have the disadvantages of a low cocoa butter (CB) tolerance. This means that fast crystallizing compounds are best suited for recipes with only cocoa powder in order to avoid undesired short shelf life due to rapid bloom formation. Most B2B customers know this and try to act accordingly.

However, there is a risk of cross contamination during production when a product line shift from a compound recipe with cocoa mass to a fast crystallizing compound powder recipe. This cross contamination may result in shortening of the latter compounds shelf life.

Furthermore, some customers (for example in the Middle East) deliberately have cocoa mass present in the fast crystallizing compound recipe. The answer to why they deliberately shorten the shelf life is customer specific and may be driven by their conviction. Maybe they state the chocolate taste is improved, others may say the meltdown is improved, others still may state it makes the compound less brittle on coating in cakes or perhaps its to obtain a more “exclusive” labelling with cocoa mass in the ingredients list. The fact is that some customers do this.

There exists a few ways to improve the cocoa butter tolerance for non-temper compounds, such as CBS. WO2017/179455 A1 and WO2020/2265144 A1 respectively describes that addition of a soft component comprising OStO to CBS and to Cocoa Butter Replacers (CBR) has shown to improve the CB tolerance to a certain degree. However, OStO addition results in a softer compound texture and the increased cocoa tolerance obtained so far needs to be improved further, to be able to cope with the cocoa mass contents needed in the recipe to obtain the strong cocoa taste.

WO2017/169623 A1 discribes a compound fat comprising a vegetable fat component with both short chain (5-15%≤C10) and long chain (2-12%≥C20) fatty acids in the triglyceride composition. The resultant compounds with up to 20-30 weight % CB in the fat phase show no bloom after 1 months at 20° C., but the fat seems to be very soft and probably most useful as a filling. WO 2020/054701 A1 discloses the same target as WO 2017/169623 A1. However, also resulting in a solution too soft to be categorized as a compound.

Therefore, there is still a need within the field to provide a non-temper edible milk application composition, where the non-temper edible milk application composition has an improved cocoa butter/cocoa mass tolerance compared to existing non-temper edible milk application composition solutions.

Accordingly, the main object of the invention is to provide an edible application composition comprising a milk fat containing component, with an improved cocoa butter/cocoa mass tolerance.

Yet another object is to provide a number of applications for such edible application compositions.

### SUMMARY OF THE INVENTION

The present invention relates to an edible application composition comprising at least the following three components:
a) a vegetable fat component, wherein
   i. the sum of saturated fatty acids is in the range from 90% to 100% by weight of said vegetable fat component,
   ii. the sum of saturated C12 fatty acids is in the range from 40% to 60% by weight of said vegetable fat component, and
   iii, the sum of mono-unsaturated C18 fatty acids is in the range from 0% to 9% by weight of said vegetable fat component, and
   iv. saturated C44:0 triglycerides comprising 44 carbons in its three fatty acid chains, are in the range from 3.3% to 7.0% by weight of said vegetable fat component; and
b) a milk fat containing component selected from milk fat, whole milk powder, and/or skim milk powder, wherein the milk fat containing component is in an amount resulting in a milk fat content in the range from 2% to 15% by weight of the total weight of the fat phase of the edible application composition; and
c) a cocoa butter containing component selected from cocoa butter, cocoa mass and/or cocoa powder, wherein the cocoa butter containing component is in an amount resulting in a cocoa butter content in the range from 5% to 13% by weight of the total weight of the fat phase of the edible application composition.

The edible application compositions of the present invention enables the production of an robust milk edible application product that has a significantly better cocoa butter/cocoa mass tolerance than existing solutions. This improved cocoa butter/cocoa mass tolerance results in a list of advantages:
Production line shifts will be easier to handle (e.g from CBR with a certain amount of cocoa mass to a CBS system with a lower amount of cocoa mass).
Increased positive customer perception of compound taste by addition of more cocoa butter/cocoa mass to a recipe using CBS,
Increased positive customer perception of compound meltdown by addition of more cocoa butter/cocoa mass to a recipe using CBS,
Increased positive customer perception of compound performance in applications,
Enabling producers to add “Cocoa butter or cocoa mass” on the product label by increasing the tolerance of the product, hereby allowing the producer to add cocoa butter/mass to the recipe.

The present invention also relates to use of a fat composition comprising:
a) a vegetable fat component, wherein
   i. the sum of saturated fatty acids is in the range from 90% to 100% by weight of said vegetable fat component,
   ii. the sum of saturated C12 fatty acids is in the range from 40% to 60% by weight of said vegetable fat component, and
   iii, the sum of mono-unsaturated C18 fatty acids is in the range from 0% to 9% by weight of said vegetable fat component, and
   iv. saturated C44:0 triglycerides comprising 44 carbons in its three fatty acid chains, are in the range from 3.3% to 7.0% by weight of said vegetable fat component; and
b) a milk fat containing component selected from milk fat, whole milk powder, and/or skim milk powder;
for increasing the cocoa butter tolerance in an edible application composition, wherein the milk fat content will be in the range from 2% to 15% by weight of the total weight of the fat phase of said edible application composition.

Use of the the edible application composition in coating or enrobing for bakery, confectionary applications, and/or molding applications; or in fillings, such as bakery fillings and confectionery fillings; or for chocolate and chocolate-like coatings is also disclosed herein.

### Definitions

In the context of the present invention, the following terms are meant to comprise the following, unless defined elsewhere in the description.

As used herein, the term “vegetable” shall be understood as originating from a plant or a single cell organism. Thus, vegetable fat or vegetable triglycerides are still to be understood as vegetable fat or vegetable triglycerides if all the fatty acids used to obtain said triglyceride or fat is of plant origin or single cell organism origin.

As used herein, the term “triglycerides” may be used interchangeably with the term “triacylglycerides” and should be understood as an ester derived from glycerol and three fatty acids. “Triglycerides” may be abbreviated TG or TAG.

Saturated fatty acids (SAFA) are chains of carbon atoms joined by single bonds, with the maximum number of hydrogen atoms attached to each carbon atom in the chain. Unsaturated fatty acids are chains of carbon atoms joined by single bonds and varying numbers of double bonds, which do not have their full quota of hydrogen atoms attached. An unsaturated fatty acid can exist in two forms, the cis form and the trans form. A double bond may exhibit one of two possible configurations: trans or cis. In trans configuration (a trans fatty acid) the carbon chain extends from opposite sides of the double bond, whereas, in cis configuration (a cis fatty acid) the carbon chain extends from the same side of the double bond.

By using the nomenclature CX means that the fatty acid comprises X carbon atoms, e.g. a C14 fatty acid has 14 carbon atoms while a C8 fatty acid has 8 carbon atoms.

By using the nomenclature CX:Y means that the fatty acid comprises X carbon atoms and Y double bonds, e.g. a C14:0 fatty acid has 14 carbon atoms and 0 double bonds while a C18:1 fatty acid has 18 carbon atoms and 1 double bond.

In general, triglycerides use a “sn” notation, which stands for stereospecific numbering. In a Fischer projection of a natural L-glycerol derivative, the secondary hydroxyl group is shown to the left of C-2; the carbon atom above this then becomes C-1 and that below becomes C-3. The prefix ‘sn’ is placed before the stem name of the compound.

Sn1/sn2/sn3:

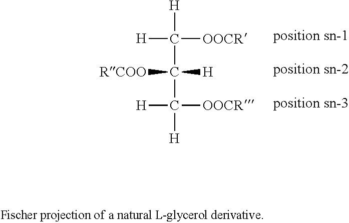

By saturated C44:0 triglycerides is meant that the triglyceride has a total of 44 carbon atoms in its three fatty acid chains and no double bond split between the three fatty acid chains in the three sn-positions. For example a triglyceride having a C18:0 fatty acid in the sn-1 position, a C14:0 fatty cid in the sn-2 position and a C12:0 fatty acid in the sn-3 position will be a saturated C44:0 triglyceride.

By randomly distributed is meant that the fatty acids is randomly distributed to the three sn-positions. A randomly distributed composition may be obtained by means of esterification, chemical transesterification or enzymatic transesterification. All naturally occurring fat compositions, e.g. virgin olive oil, palm kernel oil, coconut oil or rapeseed oil all have a non-randomly distribution of the fatty acids on the glycerol backbone.

By vegetable fat component is meant a vegetable fat originating from a plant or a single cell organism. The vegetable fat component can e.g. be selected from the group of palm kernel oil, coconut oil, high lauric rapeseed oil, palm oil or a blend thereof, and/or fractions thereof. It can also be selected from an interesterified, fractionated, and/or hydrogenated version of palm kernel oil, coconut oil, high lauric rapeseed oil, palm oil or a blend thereof, and/or fractions thereof.

As used herein, “%” or “percentage” relates to weight percentage i.e. wt. % or wt.-% if nothing else is indicated.

The sum of a given component in the vegetable fat composition can never be more than 100% by weight, e.g. the sum of all the fatty acid in the vegetable fat composition can never be more than 100% by weight.

As used herein, “oil” and “fat” are used interchangeably, unless otherwise specified.

As used herein, “vegetable oil” and “vegetable fat” are used interchangeably, unless otherwise specified.

As used herein the term “single cell oil” shall mean oil from oleaginous microorganisms which are species of yeasts, molds (fungal), bacteria and microalgae. These single cell oils are produced intracellular and in most cases during the stationary growth phase under specific growth conditions (e.g. under nitrogen limitation with simultaneous excess of a carbon source). Examples of oleaginous microorganisms are, but not limited to, Mortierella alpineea, Yarrowia lipolytica, Schizochytrium, Nannochloropsis, Chlorella, Crypthecodinium cohnii, Shewanella.

As used herein “cocoa butter substitute”, CBS, is intended to mean an edible fat having a triglyceride composition very different to cocoa butter. Most cocoa butter substitutes are based on lauric fats, i.e. fats that contain a high amount of lauric acids in their fatty acid composition. Cocoa butter substitutes are only mixable with cocoa butter in small ratios. Furthermore, cocoa butter substitutes are non-temper fat compositions so in contrast to chocolate, cocoa butter substitute based compounds do not need to undergo a treatment at different temperatures, known as tempering, prior to molding, coating, or enrobing, in order to obtain a final product with acceptable form stability and/or shelf life.

As used herein “edible” is something that is suitable for use as food or as part of a food product, such as a dairy or confectionary product.

For products and methods in the confectionery areas, reference is made to “Chocolate, Cocoa and Confectionery”, B. W. Minifie, Aspen Publishers Inc., 3. Edition 1999.

A food product is a product for human consumption.

By a chocolate or chocolate-like product is meant a product, which at least is experienced by the consumer as chocolate or as a confectionery product having sensorial attributes common with chocolate, such as e.g. melting profile, taste etc. Some chocolate comprises cocoa butter, typically in substantial amounts, where some chocolate-like product may be produced with a low amount of or even without cocoa butter, e.g. by replacing the cocoa butter with a cocoa butter equivalent, cocoa butter substitute, etc. In addition, many chocolate or chocolate-like products comprise cocoa powder or cocoa mass, although some chocolate or chocolate-like products, such as typical white chocolates, may be produced without cocoa powder, but e.g. drawing its chocolate taste from cocoa butter. Depending on the country and/or region there may be various restrictions on which products may be marketed as chocolate.

By compound is meant a product made from a combination of cocoa butter and (vegetable) fats. A compound may also comprise milk fat in various amounts. It is used as a lower-cost alternative to true chocolate, as it uses less-expensive hard (vegetable) fats in place of the more expensive cocoa butter. It may also be known as “compound coating” or “chocolatey coating” when used as a coating for confectionary or candy.

The term “comprising” or “to comprise” is to be interpreted as specifying the presence of the stated parts, steps, features, or components, but does not exclude the presence of one of more additional parts, steps, features, or components.

As used herein, the term “and/or” is intended to mean the combined (“and”) and the exclusive (“or”) use, i.e. “A and/or B” is intended to mean “A alone, or B alone, or A and B together”.

As used herein the term “fat phase” is defined as the part of a composition constituting the fat content of said composition.

### DETAILED DESCRIPTION OF THE INVENTION

When describing the below embodiments, the present invention envisages all possible combinations and permutations of the below described embodiments with the above disclosed aspects.

The invention relates to an edible application composition comprising at least the following three components:
a) a vegetable fat component, wherein
   i. the sum of saturated fatty acids is in the range from 90% to 100% by weight of said vegetable fat component,
   ii. the sum of saturated C12 fatty acids is in the range from 40% to 60% by weight of said vegetable fat component,
   iii, the sum of mono-unsaturated C18 fatty acids is in the range from 0% to 9% by weight of said vegetable fat component, and
   iv. saturated C44:0 triglycerides comprising 44 carbons in its three fatty acid chains, are in the range from 3.3% to 7.0% by weight of said vegetable fat component;
b) a milk fat containing component selected from milk fat, whole milk powder, and/or skim milk powder, wherein the milk fat containing component is in an amount resulting in a milk fat content in the range from 2% to 15% by weight of the total weight of the fat phase of the edible application composition; and
c) a cocoa butter containing component selected from cocoa butter, cocoa mass, and/or cocoa powder, wherein the cocoa butter containing component is in an amount resulting in a cocoa butter content in the range from 5% to 13% by weight of the total weight of the fat phase of the edible application composition.

The vegetable fat component in a) can be a cocoa butter substitute (CBS).

Hence, the present invention further relates to an edible application composition comprising at least the following three components:
a) a cocoa butter substitute (CBS) component wherein the sum of saturated C12 fatty acids is in the range from 20% to 65% by weight of said CBS component;
b) a milk fat containing component selected from milk fat, whole milk powder, and/or skim milk powder, wherein the milk fat containing component is in an amount resulting in a milk fat content in the range from 2% to 15% by weight of the total weight of the fat phase of the edible application composition; and
c) a cocoa butter containing component selected from cocoa butter, cocoa mass, and/or cocoa powder, wherein the cocoa butter containing component is in an amount resulting in a cocoa butter content in the range from 5% to 13% by weight of the total weight of the fat phase of the edible application composition.

The edible application composition of the present invention has a significantly higher amount of a cocoa butter containing component than existing non-temper solutions in the market.

The shelf life of the manufactured compounds of the present invention is increased. The results shows that the milk compounds with approximately 10% cocoa butter in the fat phase do not display bloom at 20° C. for both tablets and coated biscuits. This is in sharp contrast to the shelf life results at 20° C. isotherm for dark compounds applications comprising 10% cocoa butter in fat phase which display accelerated bloom formation as compared to the dark compound applications with only 5% cocoa butter in fat phase.

In addition to increased shelf life, other advantages such as more robust production line shifts, increased positive customer perception of compound taste by addition of more cocoa butter/cocoa mass, increased positive customer perception of compound meltdown by addition of more cocoa butter/cocoa mass, and increased positive customer perception of compound performance in applications is seen.

The edible application composition of the present invention also enables producers to add “Cocoa butter or cocoa mass” on the product label.

One of the benefit for the producer of such edible application compounds is reduction of the risk of blooming of their edible applications compounds due to a to high content of cocoa butter and/or cocoa mass in their compound recipe (either deliberately added or via cross contamination on the production line).

In one or more embodiments, the sum of saturated fatty acids is in the range from 91% to 100% by weight, such as 92% to 100% by weight of said vegetable fat component.

In one or more embodiments, sum of saturated fatty acids is at least 90% by weight, such as at least 91% by weight, such as at least 92% by weight.

In one or more embodiments, the the sum of saturated C12 fatty acids is in the range from of 43% to 59% by weight, such as 45% to 58% by weight, such as 47% to 57% by weight of said vegetable fat component.

In one or more embodiments, the sum of mono-unsaturated C18 fatty acids is in the range from 0% to 8%, such as 0% to 7% by weight of said vegetable fat component.

In one or more embodiments, the sum of saturated C44:0 triglycerides comprising 44 carbons in its three fatty acid chains, are in the range from 3.5% to 7.0% by weight, such as 3.8% to 6.6% by weight, such as 4.0% to 6.4% by weight of said vegetable fat component.

In one or more embodiments, the vegetable fat component is a CBS component.

In one or more embodiments, the cocoa butter containing component is in an amount resulting in a cocoa butter content in the range from 6% to 12% by weights, such as 7% to 12% by weight of the total weight of the fat phase of the edible application composition.

In one or more embodiments, the milk fat containing component is in an amount resulting in a milk fat content in the range from 3% to 13% by weight, such as 4% to 12% by weight of the total weight of the fat phase of the edible application composition.

In one or more embodiment, the vegetable fat component may comprise a component comprising randomly distributed fatty acids obtained by esterification of glycerol with free fatty acids. There are different ways of doing this. One possible way is to mix glycerol and free fatty acids and heat the reaction mixture to 70° C. The reaction mixture is then heated to 170° C. over 30 minutes under reduced pressure of approx. 100-150 mbar and further kept at 170-180° C. for 7 hours where the reduced pressure is lowered stepwise to 33 mbar as reaction time progress. Then the temperature is raised to 210° C. Once the final reaction temperature of 210° C. is reached, the reaction mixture is left for 2 hours. The excess free fatty acids from the obtained crude oil can be distilled of at 240° C. under reduced pressure before the oil can be bleached, filtered, and deodorized.

In one or more embodiment, the randomly distributed fatty acids may be obtained by interesterification or a transesterification of vegetable oil parts, such as a chemically interesterification of vegetable oil parts.

In one or more embodiment, the vegetable oil parts are selected from palm stearin and palm kernel stearin.

Interesterification, transesterification e.g. such as chemically interesterification are standard methods known to persons skilled in the art and it is well within the skills of persons skilled in the art to define parameters and conditions to successfully perfom the methods.

In one or more embodiments, the vegetable fat component is not originating from a single cell organism.

The present disclosure also comprise use of a fat composition comprising:
a) a vegetable fat component, wherein
   i. the sum of saturated fatty acids is in the range from 90% to 100% by weight of said vegetable fat component,
   ii. the sum of saturated C12 fatty acids is in the range from 40% to 60% by weight of said vegetable fat component, and
   iii, the sum of mono-unsaturated C18 fatty acids is in the range from 0% to 9% by weight of said vegetable fat component, and
   iv. saturated C44:0 triglycerides comprising 44 carbons in its three fatty acid chains, are in the range from 3.3% to 7.0% by weight of said vegetable fat component; and
b) a milk fat containing component selected from milk fat, whole milk powder, and/or skim milk powder;
for increasing the cocoa butter tolerance in an edible application composition, wherein the milk fat content will be in the range from 2% to 15% by weight of the total weight of the fat phase of said edible application composition.

In one or more embodiment of the use of the fat composition according to the above, the sum of saturated fatty acids is in the range from 91% to 100% by weight, such as 92% to 100% by weight of said vegetable fat component.

In one or more embodiment of the use of the fat composition according to the above, the sum of saturated C12 fatty acids is in the range from of 43% to 59% by weight, such as 45% to 58% by weight, such as 47% to 57% by weight of said vegetable fat component.

In one or more embodiment of the use of the fat composition according to the above, the sum of mono-unsaturated C18 fatty acids is in the range from 0% to 8%, such as 0% to 7% by weight of said vegetable fat component.

In one or more embodiment of the use of the fat composition to the above, the sum of saturated C44:0 triglycerides comprising 44 carbons in its three fatty acid chains, are in the range from 3.5% to 7.0% by weight, such as 3.8% to 6.6% by weight, such as 4.0% to 6.4% by weight of said vegetable fat component.

In one or more embodiment of the use of the fat composition according to the above, the vegetable fat component in a) is a CBS component.

The present invention further relates to use a fat composition comprising:
a) a cocoa butter substitute (CBS) component wherein the sum of saturated C12 fatty acids is in the range from 20% to 65% by weight of said CBS component; and
b) a milk fat containing component selected from milk fat, whole milk powder, and/or skim milk powder;
for increasing the cocoa butter tolerance in an edible application composition, wherein the milk fat content will be in the range from 2% to 15% by weight of the total weight of the fat phase of said edible application composition.

Further disclosed is also the use of a fat composition comprising a milk fat containing component selected from milk fat, whole milk powder, and/or skim milk powder for increasing the cocoa butter tolerance in an edible application composition comprising a cocoa butter substitute (CBS) component, wherein the milk fat content will be in the range from 2% to 15% by weight of the total weight of the fat phase of said edible application composition.

In one or more embodiment of any of the uses of the fat composition according to the present disclosure, the cocoa butter tolerance is increased to allow a cocoa butter content in the range from 5% to 13% by weight of the total weight of the fat phase of the edible application composition. In one or more embodiments, the cocoa butter content results from a cocoa butter containing component selected from cocoa butter, cocoa mass, and/or cocoa powder.

In one or more embodiment of any of the uses of the fat composition according to the present disclosure, the cocoa butter content is in the range from 6% to 12% by weights, such as 7% to 12% by weight of the total weight of the fat phase of the edible application composition.

In one or more embodiment of any of the uses of the fat composition according to the present disclosure, the milk fat content will be in the range from 3% to 13% by weight, such as 4% to 12% by weight of the total weight of the fat phase of the edible application composition.

Also disclosed herein is the use of the edible application composition according to the present disclosure in coating or enrobing for bakery, confectionery, and/or molding applications.

Also disclosed herein is the use of the edible application composition according to the present disclosure in fillings, such as bakery fillings and confectionery fillings.

Also disclosed herein is the use of the edible application composition according to the present disclosure for chocolate and chocolate-like coatings.

When describing the embodiments, the combinations and permutations of all possible embodiments have not been explicitly described. Nevertheless, the mere fact that certain measures are recited in mutually different dependent claims or described in different embodiments does not indicate that a combination of these measures cannot be used to advantage. The present invention envisage all possible combinations and permutations of the described embodiments.

The present invention is further illustrated by the following examples, which are not to be construed as limiting the scope of protection.

### EXAMPLES

### Example 1—Vegetable Fat Compositions

Three vegetable fat components are made:

Vegetable fat composition A is based on hydrogenated palm kernel stearin; and

vegetable fat composition B is based on a blend of palm kernel stearin and a component based on chemically inter-esterified blend of 85% palm stearin IV 6 and 15% palm kernel stearin.

The chemically inter-esterified blend is produced via chemical inter esterification of vegetable oil components in an oil reaction mixture. This is a standard method. The following is one way of carrying out the method. The acid degree (°S) of the mixture are determined, and if the value is above 2, the mixture should be neutralised before heating the mixture to 125° C. for at least an hour under reduced pressure followed by cooling to the preferred temperature depending on the melting point of the mixture. After cooling the mixture, sodium methylate is added to the mixture and the mixture is mixed under vacuum for approximate 1 to 3 hours, followed by a PH neutralising step. The mixture is dried under vacuum and the mixture is bleached and filtered to yield the final vegetable fat composition.

Comparative vegetable fat composition C is based on palm kernel stearin

Table 1 displays the feed composition, fatty acid composition (FAC), as well as the solid fat content (SFC) profile of the vegetable fat compositions. Solid fat content (SFC) is a measure of the percentage of fat in crystalline (solid) phase to total fat (the remainder being in liquid phase) at a specific temperature or temperature range, measured across a temperature gradient.

TABLE 1
Feed compositions, FAC and SFC profiles
on vegetable fat compositions.

| Vegetable fat composition | A | B | Comp C |
|---|---|---|---|
| Hydrogenated palm kernel stearin (% w/w) | 100.0 | | |
| Palm kernel stearin (% w/w) | | 85.0 | 100.0 |
| RX of blend of palm stearin and | | 15.0 | |
| palm kernel stearin (% w/w) | | | |
| Fatty acid composition | | | |
| C8:0 (% w/w) | 1.9 | 1.7 | 1.9 |
| C10:0 (% w/w) | 2.8 | 2.6 | 2.8 |
| C12:0 (% w/w) | 54.2 | 48.0 | 54.2 |
| C14:0 (% w/w) | 21.7 | 18.5 | 21.7 |
| C16:0 (% w/w) | 9.0 | 18.8 | 9.0 |
| C18:0 (% w/w) | 10.3 | 2.5 | 2.2 |
| C18:1 (% w/w) | — | 6.8 | 7.1 |
| C18:2 (% w/w) | — | 1.0 | 1.0 |
| SAFA (% w/w) | 100.0 | 92.2 | 91.8 |
| Selected TAG composition | | | |
| TAG C44:0 (% w/w) | 4.8 | 4.5 | 2.7 |
| Solid fat content (SFC) | | | |
| SFC (20 °C) | 95.3 | 85.2 | 84.2 |
| SFC (25 °C) | 89.6 | 71.1 | 66.8 |
| SFC (30 °C) | 47.7 | 31.8 | 29.1 |
| SFC (35 °C) | 3.6 | 3.8 | <0.5 |
| SFC (40 °C) | <0.5 | <0.5 | <0.5 |

The fatty acid compositions of the vegetable fat compositions were analyzed using IUPAC 2.301 (Methylation) and IUPAC 2.304 (GLC). The TAG composition were analyzed using ISO 17383. The solid fat content (SFC) was measured according to IUPAC 2.150a.

### Example 2—Recipes and Manufacture of Dark and Milk Chocolate-Like Compounds

Table 2 and 3 display the recipes for the dark and milk chocolate-like compounds.

TABLE 2
Composition of dark chocolate-like compounds.

| Compound recipes | Dark 1 | Dark 2 | Dark 3 |
|---|---|---|---|
| Vegetable fat composition (% w/w) | 29.4 | 27.9 | 26.2 |
| Cocoa mass (% w/w) | — | 3.2 | 6.4 |
| Cocoa powder (10-12% CB) (% w/w) | 15.0 | 13.3 | 11.8 |
| Sugar (% w/w) | 48.6 | 48.6 | 48.6 |
| Skim milk powder (% w/w) | 6.0 | 6.0 | 6.0 |
| STS (% w/w) | 0.6 | 0.6 | 0.6 |
| Lecithin | 0.4 | 0.4 | 0.4 |
| Total fat content (% w/w) | 31.8 | 31.8 | 31.8 |
| The fat composition | | | |
| distribution in the recipe | | | |
| Vegetable fat (% w/w) | 94.6 | 89.6 | 84.5 |
| Cocoa butter (% w/w) | 5.2 | 10.2 | 15.3 |
| Milk fat (% w/w) | 0.2 | 0.2 | 0.2 |

TABLE 3
Composition of milk chocolate-like compounds.

| Compound recipes | Milk 1 | Milk 2 | Milk 3 |
|---|---|---|---|
| Vegetable fat composition (% w/w) | 28.4 | 25.9 | 24.4 |
| Cocoa mass (% w/w) | — | 5.0 | 8.0 |
| Cocoa powder (10-12% CB) (% w/w) | 5.0 | 2.5 | 1.0 |
| Sugar (% w/w) | 47.6 | 47.6 | 47.6 |
| Skim milk powder (% w/w) | 11.0 | 11.0 | 11.0 |
| Whole milk powder (% w/w) | 7.0 | 7.0 | 7.0 |
| STS (% w/w) | 0.6 | 0.6 | 0.6 |
| Lecithin | 0.4 | 0.4 | 0.4 |
| Total fat content (% w/w) | 31.5 | 31.5 | 31.5 |
| The fat composition | | | |
| distribution in the recipe | | | |
| Vegetable fat (% w/w) | 92.1 | 84.1 | 79.3 |
| Cocoa butter (% w/w) | 1.8 | 9.8 | 14.6 |
| Milk fat (% w/w) | 6.1 | 6.1 | 6.1 |

All the ingredients for the dark and milk chocolate-like compounds were mixed in a Hobart N-50 mixer at 65° C. and 55° C. for ten minutes, respectively, and thereafter refined in a Bühler SDY-300 three-roll refiner to a particle size of approximately 20μ. Hereafter, the dark and milk chocolate-like compounds were conched in the Hobart mixer for 6 hours at 65° C. and 55° C., respectively. The compounds were subsequently deposited into 50 g tablets and used for coating on biscuits. Both applications were cooled in three zone cooling tunnel for 30 minutes at a temperature of 6° C. for 20 minutes followed by a temperature of 15° C. for 10 minutes.

### Example 3—Shelf Life Evaluation

The molded 50 grams tablets and enrobed biscuits of dark compounds A1 to A3, B1 to B3, C1 to C3 and milk compounds A4 to A6, B4 to B6, C4 to C6 were stored at 20° C. for one week and then inserted into temperature-controlled cabinets for consequent shelf life evaluation at 15 and 20° C. isotherm, respectively.

Table 4, 5 and 6 illustrate the time in weeks for the first appearance of bloom on the surface of the 50 gram tablets and the enrobed biscuits stored at the different storage conditions for dark compounds of vegetable fat compositions A, B and C.

TABLE 4
Shelf life for dark compound of vegetable fat composition A with
approximately 5, 10, and 15% cocoa butter in fat composition.

| Dark compounds | | |
|---|---|---|
| A1 | A2 | A3 |
| Dark compound recipe | | |
| Dark 1 | Dark 2 | Dark 3 |
| Vegetable Fat Mixture | | |
| A | A | A |

Weeks

| | | | |
|---|---|---|---|
| 50 g tablets | | | |
| 15 °C | 26 | 6 | 4 |
| 20 °C | >52 | 14 | 7 |
| Enrobed biscuits | | | |
| 15 °C | 18 | 4 | 4 |
| 20 °C | >52 | 4 | 2 |

TABLE 5
Shelf life for dark compound of vegetable fat composition B with
approximately 5, 10, and 15% cocoa butter in fat composition.

| Dark compounds | | |
|---|---|---|
| B1 | B2 | B3 |
| Dark compound recipe | | |
| Dark 1 | Dark 2 | Dark 3 |
| Vegetable Fat Mixture | | |
| B | B | B |

Weeks

| | | | |
|---|---|---|---|
| 50 g tablets | | | |
| 15 °C | 35 | 9 | 5 |
| 20 °C | >52 | 18 | 8 |
| Enrobed biscuits | | | |
| 15 °C | 20 | 7 | 4 |
| 20 °C | >52 | 6 | 4 |

TABLE 6
Shelf life for dark compound of vegetable fat composition C with
approximately 5, 10, and 15% cocoa butter in fat composition.

| Dark compounds | | |
|---|---|---|
| C1 | C2 | C3 |
| Dark compound recipe | | |
| Dark 1 | Dark 2 | Dark 3 |
| Vegetable Fat Mixture | | |
| C | C | C |

Weeks

| | | | |
|---|---|---|---|
| 50 g tablets | | | |
| 15 °C | 12 | 2 | 2 |
| 20 °C | >20 | 3 | 2 |
| Enrobed biscuits | | | |
| 15 °C | 8 | 1 | 1 |
| 20 °C | >20 | 3 | 2 |

It is clearly evident that the time for observable bloom on the surface of tablets and coated biscuits are drastically reduced when the cocoa butter content of the compound fat phase is increased (Dark compounds A2, A3, B2, B3, C2 and C3). This relates well to the confectionery fat teachings that the shelf life for CBS compounds are very sensitive to increases in cocoa butter content of the fat phase above 5%.

Table 7, 8 and 9 illustrate the time in weeks for the first appearance of bloom on the surface of the 50 gram tablets and the enrobed biscuits stored at the different storage conditions for milk compounds of vegetable fat compositions A, B and C.

TABLE 7
Shelf life for milk compound of vegetable fat composition A with
approximately 2, 10, and 15% cocoa butter in fat composition.

| Milk compounds | | |
|---|---|---|
| A4 | A5 | A6 |
| Milk compound recipe | | |
| Milk 1 | Milk 2 | Milk 3 |
| Vegetable Fat Mixture | | |
| A | A | A |

Weeks

| | | | |
|---|---|---|---|
| 50 g tablets | | | |
| 15 °C | 30 | 14 | 5 |
| 20 °C | >52 | >28 | 14 |
| Enrobed biscuits | | | |
| 15 °C | 24 | 7 | 3 |
| 20 °C | >52 | >28 | 5 |

TABLE 8
Shelf life for milk compound of vegetable fat composition B with
approximately 2, 10, and 15% cocoa butter in fat composition.

| Milk compounds | | |
|---|---|---|
| B4 | B5 | B6 |
| Milk compound recipe | | |
| Milk 1 | Milk 2 | Milk 3 |
| Vegetable Fat Mixture | | |
| B | B | B |

Weeks

| | | | |
|---|---|---|---|
| 50 g tablets | | | |
| 15 °C | >52 | 14 | 5 |
| 20 °C | >52 | 44 | 14 |
| Enrobed biscuits | | | |
| 15 °C | >52 | 12 | 3 |
| 20 °C | >52 | 42 | 5 |

TABLE 9
Shelf life for milk compound of vegetable fat composition C with
approximately 2, 10, and 15% cocoa butter in fat composition.

| Milk compounds | | |
|---|---|---|
| C4 | C5 | C6 |
| Milk compound recipe | | |
| Milk 1 | Milk 2 | Milk 3 |
| Vegetable Fat Mixture | | |
| C | C | C |

Weeks

| | | | |
|---|---|---|---|
| 50 g tablets | | | |
| 15 °C | 16 | 3 | 2 |
| 20 °C | >30 | 4 | 2 |
| Enrobed biscuits | | | |
| 15 °C | 12 | 1 | 1 |
| 20 °C | >30 | 4 | 2 |

It is clearly evident that the time for observable bloom on the surface of tablets and coated biscuits are drastically reduced for milk compounds A6, B6 and C6 when the cocoa butter content of the compound fat phase is approximately 15%. Furthermore, short shelflife is also observed for milk compound C5 with a cocoa butter content of the fat phase of approximately 10%. This is again in alignment with the confectionery fat teachings. However, surprisingly the milk compounds A5 and B5 with approximately 10% cocoa butter in the fat phase do not display bloom at 20° C. for both tablets and coated biscuits even after more than 28 weeks of storage. This observation is in sharp contrast to the shelf life results at 20° C. isotherm for dark compounds applications with 10% cocoa butter in fat phase which display accelerated bloom formation as compared to the dark compound applications with 5% cocoa butter in fat phase. Thus, it is evident that the presence of milk fat in the fat phase for the milk applications of the invention increase the shelf life in recipes with cocoa butter contents well above the recommended 5% of fat phase.

This is an intriguing finding as it gives the compound producer some benefits by either deliberately adding cocoa mass or cocoa butter in the milk compound recipe to improve the chocolate taste or having a milk compound more robust towards cocoa butter contamination as a result of compound shifts on the production line.

Wang, F. et al. (Eur. J. Lipid Sci. Technol. 2010, vol. 112, pp. 1270-1276. “Effect of fat composition on texture and bloom of lauric compound chocolate”) discloses i.a. an edible application composition comprising 45% by weight C12 fatty acids, 6% by weight milk fat, and 10 or 15% by weight cocoa butter (table 4).

The combination of 6% by weight milk fat and 10% by weight cocoa butter resulted in appearance of bloom after 2 weeks, and the combination of 6% by weight milk fat and 15% by weight cocoa butter resulted in appearance of a bloom after only 1 week.

These bloom appearance experiments were compared with the bloom appearance experiments carried out on edible application compositions of the present patent application, comprising 54% by weight C12 fatty acids, 6% by weight milk fat, 10 or 15% by weight cocoa butter, and 0.6% (about 2% by weight in the fat phase) by weight sorbitantristearat (STS).

The combination of 6% by weight milk fat, 10% by weight cocoa butter, and 0.6% by weight STS resulted in appearance of bloom after 24 weeks, and the combination of 6% by weight milk fat, 15% by weight cocoa butter, and 0.6% by weight STS resulted in appearance of bloom after 14 weeks (table 7 above).

Thus, the addition of STS according to the edible application composition of the present patent application results in a much later appearance of bloom, i.e. about 14 times later compared to Wang et al., and acts synergistic or additively to the milk fat. In practice the skilled person would add STS in an amount of 0.5 to 3% by weight of the fat phase for obtaining a bloom inhibiting effect.

1. A composition comprising a fat phase comprising at least the following three components:
a) a vegetable fat component, wherein
i. a sum of saturated fatty acids is in the range from 90% to 100% by weight of said vegetable fat component,
ii. a sum of saturated C12 fatty acids is in the range from 40% to 60% by weight of said vegetable fat component,
iii. a sum of mono-unsaturated C18 fatty acids is in the range from 0% to 9% by weight of said vegetable fat component, and
iv. saturated C44:0 triglycerides comprising 44 carbons in its three fatty acid chains, are in the range from 3.3% to 7.0% by weight of said vegetable fat component,
b) a milk fat containing component selected from milk fat, whole milk powder, and/or skim milk powder, wherein the milk fat containing component is in an amount resulting in a milk fat content in the range from 2% to 15% by weight of the total weight of the fat phase of the edible application composition; and
c) a cocoa butter containing component selected from cocoa butter, cocoa mass, and/or cocoa powder, wherein the cocoa butter containing component is in an amount resulting in a cocoa butter content in the range from 5% to 13% by weight of the total weight of the fat phase of the composition.

2. The edible composition according to claim 1, wherein the sum of saturated fatty acids is in the range from 91% to 100% by weight of said vegetable fat component.

3. The edible composition according to claim 1, wherein the sum of saturated C12 fatty acids is in the range from 43% to 59% by weight of said vegetable fat component.

4. The edible composition according to claim 1, wherein the sum of mono-unsaturated C18 fatty acids is in the range from 0% to 8% by weight of said vegetable fat component.

5. The edible composition according to claim 1, wherein the sum of saturated C44:0 triglycerides comprising 44 carbons in its three fatty acid chains, are in the range from 3.5% to 7.0% by weight of said vegetable fat component.

6. The edible composition according to claim 1, wherein the vegetable fat component is a cocoa butter substitute component.

7. The edible composition according to claim 1, wherein the cocoa butter containing component is in an amount resulting in a cocoa butter content in the range from 6% to 12% by weight of the total weight of the fat phase of the composition.

8. The edible composition of claim 1, wherein the milk fat containing component is in an amount resulting in a milk fat content in the range from 3% to 13% by weight the total weight of the fat phase of the composition.

9. A method of making a fat composition comprising addition of:
a) a vegetable fat component, wherein
i. a sum of saturated fatty acids is in the range from 90% to 100% by weight of said vegetable fat component,
ii. a sum of saturated C12 fatty acids is in the range from 40% to 60% by weight of said vegetable fat component, and
iii. a sum of mono-unsaturated C18 fatty acids is in the range from 0% to 9% by weight of said vegetable fat component, and
iv. saturated C44:0 triglycerides comprising 44 carbons in its three fatty acid chains, are in the range from 3.3% to 7.0% by weight of said vegetable fat component; and
b) a milk fat containing component selected from milk fat, whole milk powder, and/or skim milk powder;
wherein the method increases the cocoa butter tolerance in a composition, wherein the milk fat content will be in the range from 2% to 15% by weight of the total weight of the fat phase of said composition.

10. The method according to claim 9, wherein the cocoa butter tolerance is increased to allow a cocoa butter content in the range from 5% to 13% by weight of the total weight of the fat phase of the composition.

11. The method according to claim 10, wherein the cocoa butter content results from a cocoa butter containing component selected from cocoa butter, cocoa mass and/or cocoa powder.

12. The method according to claim 9, wherein the sum of saturated fatty acids is in the range from 91% to 100% by weight of said vegetable fat component.

13. The method according to claim 9, wherein the sum of saturated C12 fatty acids is in the range from 43% to 59% by weight of said vegetable fat component.

14. The method according to claim 9, wherein the sum of mono-unsaturated C18 fatty acids is in the range from 0% to 8% by weight of said vegetable fat component.

15. The method according to claim 9, wherein the sum of saturated C44:0 triglycerides comprising 44 carbons in its three fatty acid chains, are in the range from 3.5% to 7.0% by weight of said vegetable fat component.

16. The method according to claim 9, wherein the vegetable fat component is a cocoa butter substitute component.

17. The method according to claim 9, wherein the milk fat content will be in the range from 3% to 13% by weight of the total weight of the fat phase of the composition.

18. A method of making a composition, comprising addition of the vegetable fat component, the milk fat containing component, and the cocoa butter containing component according to claim 1, the composition employed in coating or enrobing for bakery, confectionery, and/or molding applications; or in fillings; or for chocolate and chocolate-like coatings.
